(19) United States
(12) Patent Application Publication
(10) Pub. No.: US 2020/0133667 A1
(43) Pub. Date: Apr. 30, 2020

(54) MICROCONTROLLER CAPABLE TO EXECUTE A CONFIGURABLE PROCESSING IN AN ACCELERATED MANNER

(71) Applicants: STMicroelectronics (Grenoble 2) SAS, Grenoble (FR); STMicroelectronics (Rousset) SAS, Rousset (FR)

(72) Inventors: Mark Wallis, Mouans Sartoux (FR); Serge Mazer, Moirans (FR); Didier Aladenise, Jarrie (FR)

(21) Appl. No.: 16/599,523

(22) Filed: Oct. 11, 2019

(30) Foreign Application Priority Data
Oct. 24, 2018 (FR) 1859815

(51) Int. Cl. G06F 9/28

(52) U.S. Cl. CPC G06F 9/28

(57) ABSTRACT

A microcontroller includes a processor and the hardware accelerator coupled to the processor. The microcontroller is programmed to execute a processing operation able to be parameterized by at least one parameter by delivering the at least one parameter from the processor to the hardware accelerator. The microcontroller can be part of an on-board vehicle computer.

### CROSS-REFERENCE TO RELATED APPLICATIONS

This application claims priority to French Patent Application No. 1859815, filed on Oct. 24, 2018, which application is hereby incorporated herein by reference.

### TECHNICAL FIELD

Embodiments of the invention relate to microcontrollers.

### BACKGROUND

A microcontroller contains one or more CPUs (processor cores), which is the core of the microcontroller. Memory, such as a ROM, EPROM, EEPROM or Flash-EPROM-type central memory, can store a program that is loaded for implementation by the microcontroller in the application. The microcontroller can also include other components such as programmable input/output peripherals. Microcontrollers can be designed for embedded applications.

### SUMMARY

Embodiments provide a microcontroller that is capable of quickly executing processing operations without excessively penalizing its execution load, while at the same time affording flexibility in terms of the type of processing operation.

According to some embodiments, it is proposed to incorporate a versatile, very fast and inexpensive hardware accelerator into a microcontroller.

According to one aspect, a microcontroller can execute a processing operation able to be parameterized by at least one parameter. The microcontroller includes a processor and a hardware accelerator coupled to the processor and is configured so as to execute, in terms of hardware, the processing operation more quickly. The processor is configured to deliver the at least one parameter to the hardware accelerator.

As the hardware accelerator is a circuit configured in terms of hardware, its cost is minimal, and it benefits from an architecture which is optimal for the processing operation, in particular in terms of execution speed. The processor is thus freed from the constraint of executing this processing operation, and the execution speed of the microcontroller is improved. Furthermore, as the execution of the processing operation is parameterizable, for example in terms of precision, the microcontroller benefits from execution flexibility that makes it possible to vary applications.

According to one embodiment, the processing operation is an iterative processing operation, and the at least one parameter comprises the number of iterations of the processing operation. The precision of the processing operation is advantageously determined solely by the number of iterations.

It is thus possible to set a compromise between desired precision and speed, and to benefit from operation which is optimized for various applications that have different constraints.

For example, the microcontroller comprises a clock signal generator configured so as to generate a clock signal, and the hardware accelerator is configured so as to execute, in terms of hardware, at least one iteration of the processing operation per clock cycle.

The hardware-based execution allows a certain number of iterations per cycle, in contrast to execution by the processor, which typically needs several clock cycles to execute one iteration.

According to one embodiment, the hardware accelerator furthermore comprises an input stage intended to receive input arguments of the processing operation, the input stage being configured so as to allow reception of next input arguments of a next execution of the processing operation, during a current execution of the processing operation.

In other words, the time during which a processing operation is executed is used to load the next input arguments of the next processing operation.

According to one embodiment, the hardware accelerator furthermore comprises an output stage intended to deliver results of the processing operation, the output stage being configured so as to deliver the results to the processor as soon as the results are available, the processor being configured so as to be blocked in a waiting state for as long as the hardware accelerator has not delivered the results thereto.

The output stage releases the results only when the processing operation is complete, and thus a read operation from the processor is queued until the results are released at the end of the processing operation.

Advantageously, the hardware accelerator is configured so as to execute, in terms of hardware, a possible next pending processing operation, immediately after having delivered the results to the processor by way of the output stage.

The input-output flow is thus able to be active without discontinuity, which is advantageous in terms of speed.

According to one embodiment, the function comprises at least one processing operation of a specific type chosen from the group comprising cosine, sine, arc-tangent, arc-sine, arc-cosine, hyperbolic sine, hyperbolic cosine, hyperbolic arc-tangent, square root, phase, modulus, exponential, natural logarithm.

According to one embodiment, the hardware accelerator is configured so as to execute, in terms of hardware, the processing operation by implementing a “CORDIC” coordinate rotation digital algorithm, which is well known per se to those skilled in the art.

According to another aspect, what is proposed is a hardware accelerator configured so as to execute, in terms of hardware, a processing operation able to be parameterized by at least one parameter more quickly, the at least one parameter being intended to be delivered by a processor of a microcontroller.

### BRIEF DESCRIPTION OF THE DRAWINGS

Other advantages and features of the invention will become apparent upon examining the detailed description of completely non-limiting embodiments and the appended drawings, in which:

FIGS. 1 to 4 show exemplary embodiments of the invention.

### DETAILED DESCRIPTION OF ILLUSTRATIVE EMBODIMENTS

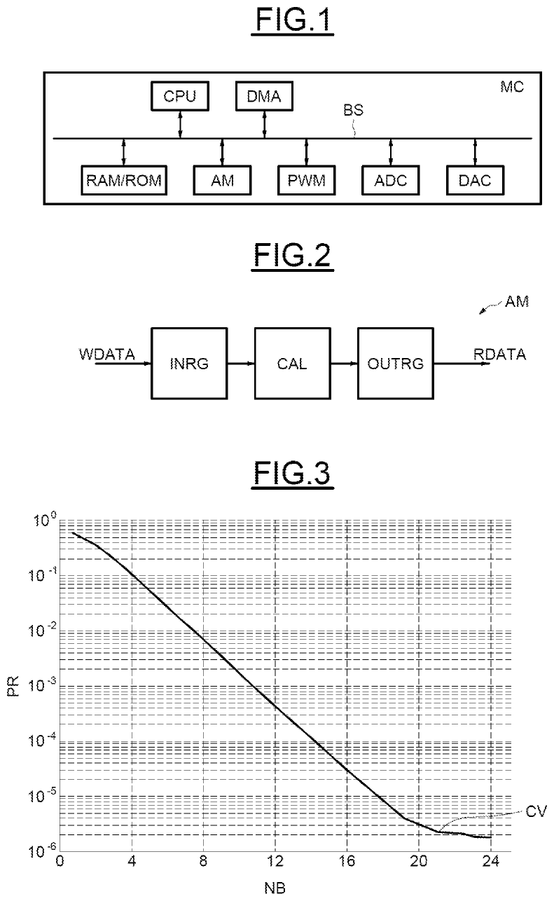

FIG. 1 shows an exemplary embodiment of a microcontroller MC intended to execute a processing operation able to be parameterized by at least one parameter.

The microcontroller MC includes a processor CPU and a hardware accelerator AM coupled to the processor CPU. The microcontroller is in particular intended to execute a processing operation. The hardware accelerator AM is configured so as to execute, in terms of hardware, the processing operation, faster than an execution that would be achieved using the processor CPU. The processing operation executed by the hardware accelerator AM is able to be parameterized by at least one parameter, and the processor CPU is configured in particular so as to deliver the at least one parameter to the hardware accelerator AM.

The microcontroller furthermore additionally includes a memory element that may comprise a random access memory RAM and a non-volatile memory ROM, a direct memory access management device DMA, input-output interfaces such as a digital-to-analogue converter DAC, an analogue-to-digital converter ADC and a pulse width modulator PWM. Furthermore, although not shown, the microcontroller MC may comprise a clock signal generator configured so as to generate a clock signal having clock cycles, intended to clock operations of the elements of the microcontroller MC.

The various elements of the microcontroller, that is to say in this example the processor, the hardware accelerator, the memory element, the direct memory access device, and the input-output interfaces, may communicate with one another via an integrated-circuit bus BS. The clock signal generator may possibly transmit the clock signal on the integrated-circuit bus BS or on a dedicated channel.

For example, the integrated-circuit bus BS is an AHB (acronym for the standard term “advanced high-performance bus”).

The parameters parameterizing the processing operation executed in terms of hardware by the hardware accelerator AM may thus be transmitted to the hardware accelerator AM and by the processor CPU via the integrated-circuit bus BS.

The processing operation is preferably of a specific type chosen for example from among trigonometric functions, hyperbolic functions or else “natural” functions, such as exponential and logarithmic functions, the root, the norm of two coordinates, the phase of two variables, etc.

The hardware accelerator is for example configured so as to execute, in terms of hardware, the processing operation by implementing a “CORDIC” coordinate rotation digital algorithm.

Due to the hardware-based execution of the processing operation by the hardware accelerator, the performance of the microcontroller is improved at a low cost. In addition, the use of the microcontroller is greatly simplified, for example in comparison with a conventional system in which a calculating unit dedicated to executing the processing operation, of DSP type, has to be programmed by the user, in particular with dedicated circuits and the required precautions.

FIG. 2 shows an exemplary embodiment of the hardware accelerator AM, for example incorporated into the microcontroller MC described above with reference to FIG. 1.

The hardware accelerator AM in this case comprises an input stage INRG, a calculating stage CAL, and an output stage OUTRG.

The calculating stage CAL is configured in terms of hardware so as to execute, in terms of hardware, the processing operation. The calculating stage is thus designed to execute the processing operation in an optimal manner at all points.

The input stage INRG is intended to receive input arguments WDATA. The input arguments WDATA comprise data on which the processing operation will be executed, for example values of input variables of a function to be calculated. The input arguments WDATA may possibly furthermore comprise a parameter parameterizing the processing operation. In this respect, the input stage INRG includes an input register, for example.

The input stage INRG is furthermore configured so as to allow reception of next input arguments WDATA of a next execution of the processing operation, during an execution of the current processing operation.

The data and the parameters are stored in the input register when the input arguments WDATA are received. The processing operation in relation thereto becomes “pending”.

The output stage OUTRG is intended to deliver results of the current processing operation RDATA. In this respect, the output stage OUTRG includes an output register, for example.

At the end of a processing operation, the results are stored in the output register of the output stage OUTRG.

According to a first alternative, an indicator signal RRDY is then activated. The indicator signal RRDY makes it possible to communicate end of processing information to the processor CPU, so that it initiates a read operation on the data RDATA in the output stage OUTRG.

According to a second alternative, the output stage OUTRG is configured so as to deliver the results RDATA to the processor CPU as soon as the results RDATA are available, and the processor CPU is configured so as to be blocked in a state of awaiting the results RDATA for as long as the hardware accelerator AM has not delivered the results thereto.

A read request for the results of the processing operation RDATA during a current processing operation will thus wait for the results to be available in order to be permitted. This means that it is not necessary for the processor CPU to sound an indicator signal RRDY or to be interrupted by such a signal.

The results RDATA are read by the processor CPU as soon as they are available, and the output flow is not interrupted.

Next, as soon as the results RDATA have been read by the processor CPU from the output stage OUTRG, the pending processing operation is executed.

The hardware accelerator AM is thus configured so as to execute, in terms of hardware, a possible next pending processing operation, immediately after having delivered the results RDATA to the processor CPU by way of the output stage OUTRG.

A new set of input arguments WDATA (comprising input data and parameters) may be written to the input stage INRG as long as there is no pending processing operation.

This means that the time spent awaiting the end of the processing operation executed in terms of hardware by the hardware accelerator AM may be used to prepare the next processing operation.

New input data WDATA may be received by the hardware accelerator AM in advance, and the input flow is not interrupted.

The input-output flow of the hardware accelerator is thus not queued and is not interrupted.

FIG. 3 illustrates a graph of the convergence of an exemplary processing operation executed in terms of hardware by the hardware accelerator AM.

In this example, the processing operation is an iterative processing operation, and the precision of the processing operation is known solely as a function of the number of iterations.

The graph of FIG. 3 shows a curve of convergence CV of the precision PR on a logarithmic scale as a function of the number of iterations NB, regardless of the values of the input variables. The convergence shown evolves at a level of 1 binary figure per iteration.

The number of iterations is directly representative of the execution speed of the processing operation, and the hardware accelerator may be configured so as to execute, in terms of hardware, at least one iteration of the processing operation per clock cycle, for example four iterations per clock cycle.

Specifically, due to the hardware-based execution of the processing operation, an optimization of this type is possible, in contrast to a conventional execution using the processor, which is typically limited to one iteration over several clock cycles.

The at least one parameter may thus comprise the number of iterations of the processing operation, so as to parameterize the speed and the precision of the processing operation.

Implementing a “CORDIC” coordinate rotation digital algorithm constitutes one advantageous example of such a processing operation.

The CORDIC (acronym for the standard expression “coordinate rotation digital computer”) algorithm is an inexpensive successive approximation algorithm, in particular for evaluating trigonometric and hyperbolic functions.

In trigonometric (circular) mode, the sine and the cosine of an angle are determined by rotating the unitary vector [1, 0] by decreasing angles until the cumulative sum of the rotation angles is equal to the input angle. The Cartesian components x and y of the pivoted vector then correspond to the cosine and to the sine of the angle, respectively.

By contrast, the angle of a vector [x, y], corresponding to the arc-tangent (y/x), is determined by rotating the vector [x, y] by successive decreasing angles in order to obtain the unitary vector [1, 0]. The cumulative sum of the rotation angles gives the angle of the original vector.

The CORDIC algorithm may also be used to calculate hyperbolic functions, by replacing the successive circular rotations with steps along a hyperbola.

Other functions may be derived from the basic functions described above.

The hardware accelerator is thus configured so as to execute, in terms of hardware, a processing operation comprising at least one function of a type chosen from the group comprising cosine, sine, arc-tangent, arc-sine, arc-cosine, hyperbolic sine, hyperbolic cosine, hyperbolic arc-tangent, square root, phase, modulus, exponential, natural logarithm.

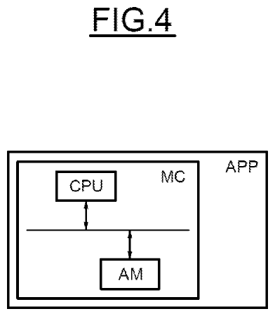

FIG. 4 illustrates an electronic appliance APP, such as an on-board vehicle computer, comprising a microcontroller MC including a hardware accelerator AM, such as described above with reference to FIGS. 1 to 3.

Moreover, the invention is not limited to these embodiments, but incorporates all variants thereof, for example, the CORDIC algorithm has been given by way of non-limiting example of one iterative processing operation with precision known as a function of the number of iterations, just as the parameters parameterizing the processing operation may be chosen depending on the processing operation.

What is claimed is:

1. A microcontroller comprising:
a processor; and
a hardware accelerator coupled to the processor;
wherein the microcontroller is programmed to execute a processing operation able to be parameterized by at least one parameter by delivering the at least one parameter from the processor to the hardware accelerator.

2. The microcontroller according to claim 1, wherein the processing operation is an iterative processing operation having a number of iterations, and the at least one parameter indicates the number of iterations of the processing operation.

3. The microcontroller according to claim 2, wherein a precision of the processing operation is able to be determined solely by the number of iterations.

4. The microcontroller according to claim 2, further comprising a clock signal generator configured so as to generate a clock signal, wherein the hardware accelerator is configured so as to execute, in terms of hardware, at least one iteration of the processing operation per clock cycle.

5. The microcontroller according to claim 1, wherein the hardware accelerator further comprises an input stage configured to receive input arguments of the processing operation, the input stage being configured so as to allow reception of next input arguments of a next execution of the processing operation during a current execution of the processing operation.

6. The microcontroller according to claim 1, wherein the hardware accelerator further comprises an output stage configured to deliver results of the processing operation, the output stage being configured so as to deliver the results to the processor as soon as the results are available and the processor being configured so as to be blocked in a waiting state for as long as the hardware accelerator has not delivered the results to the processor.

7. The microcontroller according to claim 6, wherein the hardware accelerator is configured so as to execute, in terms of hardware, a possible next pending processing operation, immediately after having delivered the results to the processor by way of the output stage.

8. The microcontroller according to claim 1, wherein the processing operation comprises a function selected from the group consisting of cosine, sine, arc-tangent, arc-sine, arc-cosine, hyperbolic sine, hyperbolic cosine, hyperbolic arc-tangent, square root, phase, modulus, exponential, and natural logarithm.

9. The microcontroller according to claim 1, wherein the hardware accelerator is configured so as to execute, in terms of hardware, the processing operation by implementing a coordinate rotation digital algorithm.

10. The microcontroller according to claim 1, wherein the microcontroller is part of an on-board vehicle computer.

11. A hardware accelerator comprising hardware configured to execute a processing operation that is able to be parameterized by at least one parameter, the at least one parameter to be delivered from a processor of a microcontroller.

12. The hardware accelerator according claim 11, further comprising an input stage configured to receive input arguments of the processing operation, wherein the input stage is configured so as to allow reception of next input arguments of a next execution of the processing operation during a current execution of the processing operation.

13. The hardware accelerator according claim 11, further comprising an output stage configured to deliver results of the processing operation as soon as the results are available and to generate a command to block the processor receiving the results for as long as the results are not delivered to the processor.

14. A method of operating a microcontroller that includes a processor and a hardware accelerator, the method comprising:
delivering a parameter from the processor to the hardware accelerator; and
executing a processing operation that is parameterized by the parameter.

15. The method according to claim 14, wherein the processing operation is an iterative processing operation and the parameter comprises a number of iterations of the processing operation.

16. The method according to claim 15, wherein a precision of the processing operation is able to be determined solely by the number of iterations.

17. The method according to claim 15, further comprising receiving a clock signal comprising clock cycles, wherein the executing the processing operation comprises executing, in terms of hardware, at least one iteration of the processing operation per clock cycle.

18. The method according to claim 14, further comprising:
receiving input arguments of a current processing operation; and
receiving next input arguments of a next execution of the processing operation during execution of the current processing operation.

19. The method according to claim 14, further comprising:
delivering results of the processing operation from the hardware accelerator to the processor as soon as the results are available; and
generating a command to block the processor for as long as the results are not delivered to the processor from the hardware accelerator.

20. The method according to claim 14, wherein the processing operation comprises a function selected from the group consisting of cosine, sine, arc-tangent, arc-sine, arc-cosine, hyperbolic sine, hyperbolic cosine, hyperbolic arc-tangent, square root, phase, modulus, exponential, and natural logarithm.

21. The method according to claim 14, wherein executing the processing operation comprises executing a “CORDIC” coordinate rotation digital algorithm.
